(19) United States
(12) Patent Application Publication
(10) Pub. No.: US 2013/0024395 A1
(43) Pub. Date: Jan. 24, 2013

(54) SYSTEM AND METHOD FOR CONSTRUCTING OUTPERFORMING PORTFOLIOS RELATIVE TO TARGET BENCHMARKS

(71) Applicants: Andrew Clark, Niwot, CO (US); Jeff Kenyon, Boulder, CO (US)

(72) Inventors: Andrew Clark, Niwot, CO (US); Jeff Kenyon, Boulder, CO (US)

(73) Assignee: Thomson Reuters (Markets) LLC, New York, NY (US)

(21) Appl. No.: 13/189,128

(22) Filed: Jul. 22, 2011

(51) Int. Cl. G06Q 40/00; G06N 3/12

(52) U.S. Cl. 705/36 R

(57) ABSTRACT

The system and method described herein may be used to construct outperforming portfolios relative to target benchmarks. In particular, the system and method described herein may use multi-factor models that employ multi-objective evolutionary algorithms and mean variance optimization calculations to select constituents from a target benchmark index to include in a portfolio. The selected constituents may then be weighed to construct or rebalance the portfolio in a manner that can consistently outperform the target benchmark index while satisfying real-world constraints that relate to turnover limits, minimum and maximum stock positions, cardinalities, target market capitalizations, investment strategies, and other characteristics associated with the portfolio.

### FIELD OF THE INVENTION

The invention generally relates to a system and method for constructing outperforming portfolios relative to target benchmarks, and in particular, to using multi-factor models that employ multi-objective evolutionary algorithms and mean variance optimization calculations to select one or more constituents from a target benchmark index to include in a portfolio and weigh the selected constituents to construct or rebalance the portfolio in a manner that can consistently outperform the target benchmark index while satisfying real-world constraints that relate to turnover limits, minimum and maximum stock positions, cardinalities, target market capitalizations, investment strategies, and other characteristics associated with the portfolio.

### BACKGROUND OF THE INVENTION

Many financial firms, portfolio and fund managers, and individual investors alike have historically attempted to develop investment strategies to generate returns that outperform or beat the returns that would otherwise be obtained from simply investing in a benchmark index. For example, comparing the performance associated with a portfolio to a target benchmark can provide insight into whether the portfolio performance was due to the predictions or forecasts that an investor or financial analysis made when choosing the particular securities and weight allocations to use in the portfolio versus external factors that may be unrelated or tangentially related to the predictions or forecasts used to construct the portfolio. However, many (if not all) investment strategies and recommendations typically carry the axiomatic caveat that past performance does not guarantee future results because overall market performance, trends within certain market or industry sectors, business and inventory cycles, and many additional factors have a highly dynamic and oftentimes unpredictable nature. As such, many investment strategies tend to chase past performance where asset allocations are shifted to sectors or securities that have been outperforming only to witness lower-than-average returns because investment conditions may change subsequent to the predictions or forecasts that were made based on the conditions that existed earlier (e.g., when those sectors or securities were outperforming the broader market).

Accordingly, assessing the investment strategy used to construct a particular portfolio over a particular time period typically entails comparing the performance associated with the portfolio to an appropriate benchmark having securities from similar asset classes, similar constituent weightings or asset allocations, and similar rebalances or turnover over the same time period. In other words, comparing how a portfolio performed relative to an appropriate benchmark may eliminate or substantially reduce the impact associated with unrelated or tangentially related factors and thereby provide a reference point to determine whether the investment strategy used to construct the portfolio outperformed a passive strategy that allows the broader market to dictate investment returns. For example, if the benchmark produced a higher return (or a lower loss) than the portfolio over the selected time period, the investor would have realized more benefits from a passive strategy than the strategy used to construct the portfolio. On the other hand, if the benchmark produced a lower return (or a greater loss) over the same time period, the investment strategy may be considered effective in beating the broader market. In either case, the comparison may yield beneficial results because the investment strategy may be continued, modified, or discarded to improve future returns.

Nonetheless, as noted above, developing effective investment strategies tends to be notoriously difficult due in no small part to the myriad factors that underlie how securities perform. For example, swings in broader economic trends that encompass consumer spending, business spending, and monetary policy, among others, tend to have substantial impacts on the business cycles that drive the overall stock market, business or industry sectors, and individual stocks. Moreover, because inflation can have a different impact on different asset types, any investment strategy should consider asset diversification that reflects how certain asset types respond to inflation (e.g., stocks may underperform during high inflation periods because rising interest rates can reduce the present value associated with future cash flows, whereas real estate may outperform during high inflation because higher present cash flows may increase asset values). Furthermore, because no two investors will typically have the same financial situation, many investment strategies have (or should have) a risk component that considers market risks relating to the economy and interest rates, risks relating to specific companies or sectors that can impact valuation, and liquidity risks relating to the changes in asset allocations, among others. As such, techniques or strategies used to construct investment portfolios may encounter many pitfalls that can undermine performance relative to benchmarks that may be agnostic to the same pitfalls since they follow the broader market. Even so, investors are always seeking new and better ways to outperform the broader market, yet existing systems tend to fall short in providing financial firms, portfolio and fund managers, and individual investors with the tools needed to achieve that elusive objective.

### SUMMARY OF THE INVENTION

According to one aspect of the invention, the system and method described herein may be used to construct outperforming stock portfolios relative to target benchmarks. In particular, the system and method described herein may satisfy real-world constraints that portfolio managers often have to deal with when building a stock portfolio. For example, turnover limits, minimum and maximum stock positions, cardinalities, target market capitalizations, and investment styles or strategies (e.g., growth or value) often constrain how portfolio managers build stock portfolios. Moreover, many portfolio managers choose stocks to include in a portfolio based on fundamental data (e.g., price-to-earnings ratios, dividend yields, etc.). In addition to these and other typical constraints and practices, portfolio managers tend to be compensated based (at least in part) on how their stock portfolios perform versus target benchmark indices. Accordingly, the system and method described herein may use multi-objective evolutionary algorithms to construct or rebalance stock portfolios that can consistently outperform typical performance benchmarks while satisfying these and other real-world constraints (e.g., maximizing an obtained geometric mean indicating central tendencies or typical values associated with the stocks in the portfolio, maximizing a Sharpe Ratio that measures a risk premium associated with the multi-factor stock model, maximizing an Information Ratio that measures a risk-adjusted return associated with the portfolio, etc.). For example, a first multi-objective evolutionary algorithm may solve various constraints relating to constructing or rebalancing a stock portfolio and generate one or more feasible portfolios that satisfy the constraints, and a second multi-objective evolutionary algorithm may then trade-off mean returns, variances, turnovers, and position limits to test the potentially feasible portfolios and identify one or more potentially feasible portfolios satisfying constraints that prevent the portfolio from having a monthly turnover over a certain threshold, require all stocks in the portfolio to have a percentage allocation within a certain range, and require all stocks in the portfolio to have a certain market capitalization or other financial fundamental metric, among other constraints. As such, the system and method described herein may then choose the best portfolio among the potentially feasible portfolios that satisfy the constraints for a current rebalance period and then re-evaluate the chosen portfolio in a next rebalance period to construct and rebalance a stock portfolio that can consistently outperform target benchmarks on a risk adjusted and non-risk adjusted basis.

According to one aspect of the invention, the system and method described herein may use one or more data repositories that include security data used to construct the portfolio, which may include data associated with one or more multi-factor models that evaluate various fundamentals associated with a stock to produce a score or recommendation associated therewith. For example, the fundamentals evaluated in the multi-factor models may include price to earnings ratios, price-to-book ratios, cash flow, or any other suitable metric that can be evaluated to produce an overall score that underlies a stock recommendation. As such, the security data may include the historical scores produced with the multi-factor models, which may be organized or otherwise delimited according to appropriate time periods.

According to one aspect of the invention, the system and method described herein may use a data preparation engine to analyze the security data contained in the data repositories and prepare a rebalance list to construct and evaluate the portfolios on a yearly, quarterly, monthly, or other suitable rebalancing basis. For example, the data preparation engine may analyze the security data to obtain candidate constituent data to seed the particular portfolio under construction, wherein the data preparation engine may search the data repositories to obtain the multi-factor model scores associated with the constituents in the target benchmark index, which may generally provide seed data to identify candidate constituents to include in the portfolio. In particular, the multi-factor model scores may generally represent forward-looking forecasts used to seed the candidate constituents and produce the portfolio in a predictive manner. Furthermore, the data preparation engine may eliminate any lines in the security data without multi-factor model scores or other necessary data deemed appropriate.

According to one aspect of the invention, the system and method described herein may use a rebalance engine to construct and evaluate the portfolio on a yearly, quarterly, monthly, or other rebalance interval. For example, the above-referenced rebalance list may include the constituents associated with the target benchmark, which may provide a candidate constituent set that represents the candidate securities to include in the portfolio. As such, the rebalance engine may load the candidate constituent set from the rebalance list and then invoke a candidate constituent engine to remove any candidate constituents that fail to satisfy goals or other constraints associated with the portfolio on an a priori basis. For example, the candidate constituent engine may remove any stocks in the candidate constituent set having multi-factor scores under a certain threshold, rank any remaining stocks in the candidate constituent set according to market capitalization, and eliminate a certain percentage of the remaining stocks that have the lowest market capitalizations. The candidate constituent engine may then calculate an aggregate market capitalization associated with the remaining stocks to determine a market capitalization floor associated with the portfolio. The candidate constituent engine may then retrieve daily price data associated with the remaining candidate constituents relative to a date associated with the current rebalance, wherein the retrieved daily price data may include various observations over a period prior to the current rebalance date based on a maximum dimensionality that constrains subsequent mean variance optimization calculations and various observations over a period subsequent to the current rebalance date to evaluate performance associated with the portfolio in the next rebalance. The candidate constituent engine may then calculate the average market capitalization and price-to-book score associated with the constituents in the target benchmark and remove from the rebalance list any constituents associated with the target benchmark not appearing in the rebalance list or having insufficient daily price data prior to the current rebalance date. In one implementation, constituents may also be excluded due to failure to fit or otherwise satisfy certain constraints on the portfolio (e.g., if the constraints require the portfolio to be growth or value oriented, any constituents that are not growth or value oriented may be excluded).

According to one aspect of the invention, the system and method described herein may then pass the remaining candidate constituents in the rebalance list to a multi-objective evolutionary algorithm, which may generally apply meta-heuristics to solve multi-objective optimization problems. For example, multi-objective optimization (or multi-objective programming) generally refers to simultaneously optimizing two or more conflicting objectives subject to certain constraints or trade-offs. Typically, while attempting to identify solutions to a non-trivial multi-objective problem, the optimization process will reach a point where attempting to further improve one objective will cause one or more other objectives to suffer or worsen, wherein a proposed solution may be called non-dominated, Pareto optimal, or Pareto efficient if the proposed solution cannot be replaced with another proposed solution that improves one or more objectives without worsening any other objectives. Multi-objective optimization problems are thus typically configured to identify such non-dominated (or Pareto optimal or Pareto efficient) solutions and quantify the trade-offs relating to how the different optimization objectives were satisfied. In this context, the multi-objective evolutionary algorithm may generally may apply Pareto-based ranking schemes to compute an optimized portfolio solution set that approximates an entire Pareto frontier in order to solve multi-objective optimization problems. For example, as will be described in further detail herein, the optimized portfolio solution set may include various portfolios with different subsets from the remaining candidate constituents passed into the multi-objective evolutionary algorithm, which may then be examined during the subsequent mean variance optimization calculations (which may also be, or include, a multi-objective evolutionary algorithm). In one implementation, the multi-objective evolutionary algorithm may include constraints that relate to how many portfolios will be included in the solution set and require all portfolios in the solution set to have a number of candidate constituents in a certain range. The multi-objective evolutionary algorithm may then identify values associated with population, generations, and mutation rate variables that constrain the algorithm, which may use single point crossover, bit flip mutation, and binary tournament selection to solve the multi-objective problem. For example, the population variable may represent how many proposed solutions will be carried from generation to generation, the generations parameter may represent how many generations the multi-objective evolutionary algorithm evaluates, and the mutation rate variable may indicate the modification rate associated with a dominated portfolio from generation to generation. Further, the population value, the generations value, the mutation rate value, the crossover type, the mutation type, and the selection method may be established by the programmer or another suitable user to configure the multi-objective evolutionary algorithm.

According to one aspect of the invention, in response to identifying the values associated with the population, generations, and mutation rate variables, the multi-objective evolutionary algorithm may then determine a current rebalance number and appropriately seed the portfolios in the population associated with the current rebalance with various candidate constituents depending on the current rebalance number. For example, if the current rebalance number has a zero value (i.e., there has not been a previous rebalance), the population in the zero-th generation rebalance may be seeded with various random portfolios that include candidate constituents randomly selected from the rebalance list. However, if the current rebalance number has a non-zero value (i.e., there has been a previous rebalance, which would have created one or more “good” portfolios), one or more portfolios from the previous rebalance may be used to seed the population in the current rebalance in addition to a sufficient number of random portfolios to suitably fill the population. The multi-objective evolutionary algorithm may then execute on the seeded population to maximize the average multi-factor scores and market capitalizations associated with the candidate constituents and/or minimize the average price-to-book score associated with the candidate constituents. As such, the multi-objective evolutionary algorithm may execute on the seeded population to identify a solution set having one or more portfolios that include candidate constituents that suitably maximize the average multi-factor scores, maximize the average market capitalizations, and/or minimize the average price-to-book score. The one or more portfolios may then be analyzed to enforce penalties relating to cardinality constraints that limit the number of portfolios in the solution set and the number of candidate constituents in each portfolio associated with the solution set. Further, in one implementation, the penalties may cause the multi-objective evolutionary algorithm to reduce a score associated with any portfolios in the solution set having average price-to-book scores that exceed the average price-to-book score associated with the constituents in the target benchmark. For example, the multi-objective evolutionary algorithm may generally score the fitness associated with the portfolios in the solution set to represent how well the portfolios satisfy (or fail to satisfy) the relevant constraints, whereby the penalties may be appropriately assessed to reduce the fitness scores associated with any portfolios that violate one or more constraints. In this context, the “evolution” metaphor may generally mean that rather from “eliminating” any portfolios outright, a portfolio having a poor fitness score will be less likely to “reproduce” (i.e., move on to the next rebalance generation).

According to one aspect of the invention, in response to the multi-objective evolutionary algorithm identifying the portfolios to include in the current rebalance solution set, the multi-objective evolutionary algorithm may produce output that contains the objective values associated therewith (i.e., the average multi-factor scores, market capitalizations, and price-to-book scores). Furthermore, the output may contain the portfolios in the solution set and a binary value that describes a Pareto efficient frontier (e.g., whether the individual candidate constituents in a particular portfolio can be allocated differently to improve one or more objective values without worsening any other objective value associated with the portfolio). In one implementation, if the current rebalance number has a non-zero value, one or more portfolios that passed the appropriate constraints in the previous rebalance may be added to the current rebalance solution set, except that any constituents in the portfolios from the prior rebalance not available in the current rebalance may be eliminated. As such, the multi-objective evolutionary algorithm may then be re-run on the portfolios in the current rebalance solution set combined with the portfolios chosen from the prior rebalance if the current rebalance number has a non-zero value. In this manner, the portfolios in the current solution set and the prior solution set may be tested against one another to identify the best portfolios from the combined prior and current rebalance solution sets.

According to one aspect of the invention, in response to the multi-objective evolutionary algorithm preparing the solution set associated with the current rebalance, the system and method described herein may invoke an optimization engine to perform the mean variance optimization calculations noted above. For example, the optimization engine may be either a standard non-linear optimizer, or alternatively a multi-objective evolutionary algorithm that can optimize the solution set with the potentially feasible portfolios, as appropriate. In one implementation, the optimization engine 160 may initially calculate daily returns associated with all candidate constituents that appear in the solution set and retrieve the daily risk free rate closest to the date associated with the current rebalance, which may be used to calculate the Sharpe Ratio that measures the risk premium associated with the multi-factor model. The optimization engine may then run the mean variance optimization calculations on each portfolio in the solution set. In particular, one portfolio in the solution set may be considered the current portfolio, wherein the mean variance optimization calculations may include forming a covariance matrix that represents returns on the candidate constituents in the current portfolio, wherein the covariance matrix may include a minimum number of daily returns to meet dimensionality constraints that require the covariance matrix to have more observations than candidate constituents. Further, the dimensionality constraints may limit the maximum daily returns that the covariance matrix can include according to the size associated with the portfolio.

According to one aspect of the invention, the optimization engine may then compute a tangency portfolio that represents a minimum risk portfolio having a highest risk-to-return ratio on the Pareto efficient frontier associated with the current portfolio. For example, the optimization engine may compute the tangency portfolio using a predefined library function or alternatively run the multi-objective evolutionary algorithm to calculate the Pareto efficient frontier and select the tangency portfolio therefrom. In the former case, the optimization engine may establish minimum and maximum weights to constrain the tangency portfolio, which may correspond to the minimum and maximum weights that reflect the candidate constituent allocations associated with the portfolio. As such, the minimum and maximum weights may provide de facto cardinality constraints that force each candidate constituent to have at least the minimum weight allocation and no more than the maximum weight allocation. In one implementation, the alternate approach to run the multi-objective evolutionary algorithm may be used to specify zero or minimum non-zero weights associated with the candidate constituents. Although the alternate approach using the multi-objective evolutionary algorithm may provide flexibility in enabling the minimum weight to be zero or a threshold non-zero value, the multi-objective evolutionary algorithm may have the additional objectives relating to return and risk, which may result in the mean variance optimization calculations becoming more time consuming than using the predefined library function.

According to one aspect of the invention, in response to computing the tangency portfolio using the predefined library function or the multi-objective evolutionary algorithm, the system and method described herein may determine whether the tangency portfolio failed to compute. If so, the optimization engine may terminate processing the current portfolio and use null values to represent a result associated therewith. Otherwise, if the tangency portfolio successfully computed, the optimization engine may calculate a turnover associated with the tangency portfolio, which may generally represent a shift in weight between the winning portfolio in the prior rebalance and the (weighted) tangency portfolio in the current rebalance. In particular, in response to determining that the calculated turnover exceeds a threshold value, the optimization engine may shift the weights associated with the portfolio from the candidate constituents selected in the mean variance optimization calculations to constituents that the winning portfolio held in the prior rebalance. For example, the optimization engine may identify the candidate constituents in the current portfolio that have been weighted, sort the identified candidate constituents in an ascending weight order, and similarly identify and sort the weighted constituents in the winning portfolio from the prior rebalance. The optimization engine may then remove all weighted constituents in the prior portfolio that either overlap with the weighted candidate constituents in the current portfolio or do not appear in any portfolio associated with the current rebalance.

According to one aspect of the invention, the optimization engine may then designate the remaining weighted constituents in the prior winning portfolio “swap candidates,” wherein the weight associated with each candidate constituent in the ordered current portfolio that was not weighted in the prior winning portfolio may be shifted to a swap candidate. The optimization engine may then recalculate the turnover with the weights shifted to the swap candidates and determine whether the recalculated turnover has a value below the threshold, in which case the weight-shifting may be terminated and the calculated values and weights associated with the optimized portfolio may be saved. On the other hand, if the recalculated turnover value continues to equal or exceed the threshold value, the optimization engine may iteratively shift the weights in the ordered current portfolio to the swap candidates until the turnover value does not equal or exceed the threshold value, or alternatively until no further swap candidates remain. In one implementation, an alternative approach may include shifting only the weights associated with the candidate constituents having the minimum weight. In response to completing the mean variance optimization calculations on all portfolios in the current solution set, the optimization engine may then select the winning portfolio (e.g., the portfolio that passed the turnover and market capitalization constraints while having the best Sharpe ratio among the passing portfolios). However, if no portfolios in the current solution set passed the turnover and market capitalization constraints, the winning portfolio may be the portfolio having the best turnover value. In either case, performance associated with the winning portfolio and the target benchmark index may be calculated and logged over the period between the dates associated with the current rebalance and the next rebalance and similar rebalancing techniques may continue when the next rebalance date arises.

According to one aspect of the invention, in addition to having applications that relate to constructing and rebalancing outperforming portfolios, the system and method described herein may have the same or substantially similar applications in various other contexts. For example, effective constructing networks and pipelines to transport data or commodities typically involves problems that relate to calculating minimum nodes and pipes to establish minimum configurations needed to ensure that all required data or commodities will be suitably transported to customers or other end users despite problems in the networks or pipelines. As such, in one implementation, the system and method described herein may employ a minimum cut solution to enforce the above-described turnover constraint, wherein the same or a substantially similar minimum cut solution may be used to determine minimum configurations to ensure maximum availability in any suitable network having pipelines constructed to transport data or commodities. In a related context, the same or substantially similar techniques may be applied to network security. For example, if security threats require isolating an internal network (or a portion thereof) from an external network or other portions associated with the internal network to secure the network from potential attacks or infection, the same or a substantially similar minimum cut solution may be used to minimize network disruption until efforts to diagnose and resolve the security threats have suitably completed. These uses may generally be achieved via the mathematics embedded in the multi-objective evolutionary algorithm, which allow the best feasible solution sets to be found very quickly while substantially reducing or eliminating the efforts that would otherwise typically be needed to search significant portions in the possible solution space. Further, the substantial reduction or elimination of the time needed to search the possible solution space has significant applicability to other contexts and allows real-time use of the multi-objective evolutionary algorithm in many instances.

Other objects and advantages of the invention will be apparent to those skilled in the art based on the following drawings and detailed description.

### BRIEF DESCRIPTION OF THE DRAWINGS

FIG. 1 illustrates an exemplary system to construct outperforming portfolios relative to a target benchmark portfolio, according to one aspect of the invention.

FIG. 2 illustrates an exemplary method to load, retrieve, and filter input data that may be used to construct portfolios, according to one aspect of the invention.

FIG. 3 illustrates an exemplary method to derive a candidate portfolio solution set using a multi-objective evolutionary algorithm, according to one aspect of the invention.

FIGS. 4A-B illustrates an exemplary method to examine a candidate portfolio solution set and construct an outperforming portfolio, according to one aspect of the invention.

### DETAILED DESCRIPTION

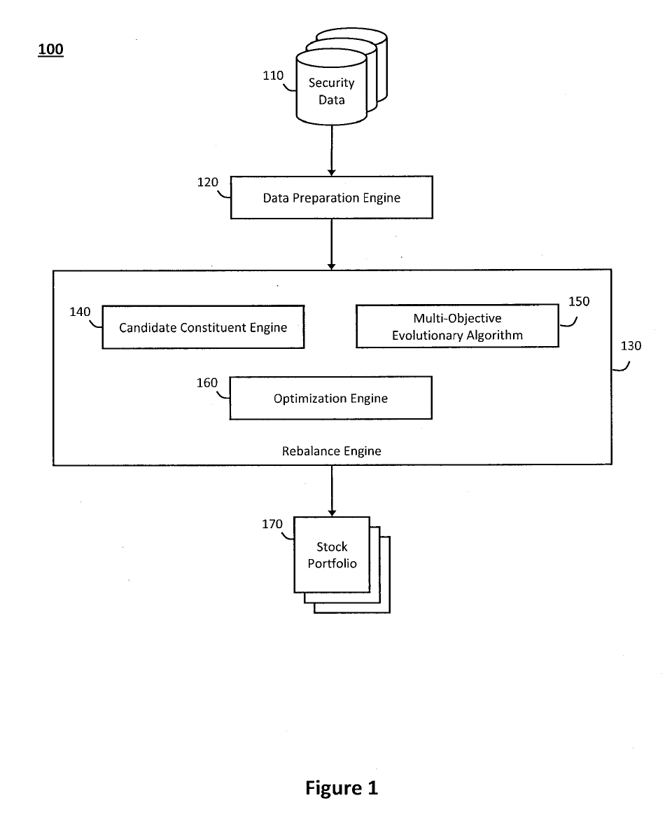

According to one aspect of the invention, FIG. 1 illustrates an exemplary system 100 to construct outperforming stock portfolios 170 relative to a target benchmark portfolio. In particular, implementations of the system 100 may be made in hardware, firmware, software, or any suitable combination thereof. The system 100 may also be implemented as instructions stored on a machine-readable medium that can be read and executed on one or more processing devices. For example, the machine-readable medium may include various mechanisms that can store and transmit information that can be read on the processing devices or other machines (e.g., read only memory, random access memory, magnetic disk storage media, optical storage media, flash memory devices, or any other storage or non-transitory media that can suitably store and transmit machine-readable information). Furthermore, although firmware, software, routines, or instructions may be described herein with respect to certain exemplary aspects and implementations performing certain actions or operations, it will be apparent that such descriptions are merely for the sake of convenience and that such actions or operations in fact result from processing devices, computing devices, processors, controllers, or other hardware executing the firmware, software, routines, or instructions. Moreover, to the extent this disclosure describes executing or performing certain operations or actions in a particular order or sequence, such descriptions are exemplary only and such operations or actions may be performed or executed in any suitable order or sequence.

In one implementation, the system 100 shown in FIG. 1 may construct the stock portfolios 170 to outperform target benchmarks, wherein the constructed stock portfolios 170 may generally include a large-cap index 170, a large-cap growth index 170, or other suitable stock portfolios 170. In particular, the system 100 may construct the stock portfolios 170 to satisfy real-world constraints that portfolio managers often have to deal with when building a stock portfolio. For example, turnover limits, minimum and maximum stock positions, cardinalities, target market capitalizations, and investment styles or strategies (e.g., growth or value) often constrain how portfolio managers build stock portfolios, while many portfolio managers choose stocks to include in a portfolio based on fundamental data (e.g., price-to-earnings ratios, dividend yields, etc.). In addition to these and other typical constraints and practices, portfolio managers tend to be compensated based (at least in part) on how their stock portfolios 170 perform versus target benchmark indices. Accordingly, the system 100 may use multi-objective evolutionary algorithms to construct or rebalance stock portfolios 170 that can consistently outperform typical performance benchmarks while satisfying these and other real-world constraints (e.g., maximizing an obtained geometric mean that indicates central tendencies or typical values associated with the stocks in the portfolios 170, maximizing a Sharpe Ratio that measures a risk premium associated with the multi-factor stock model to build the stock portfolios 170, maximizing an Information Ratio that measures a risk-adjusted return associated with the stock portfolios 170, etc.). For example, in one implementation, a first multi-objective evolutionary algorithm 150 may solve various constraints relating to constructing or rebalancing a stock portfolio 170 and generate one or more feasible portfolios that satisfy the constraints, while a second multi-objective evolutionary algorithm may then trade-off mean returns, variances, turnovers, and position limits to test the potentially feasible portfolios and identify one or more potentially feasible portfolios satisfying constraints that prevent a particular portfolio 170 from having a monthly turnover percentage over a certain threshold (e.g., eight percent), require all stocks in the portfolio 170 to have an allocation between a minimum and maximum percentage (e.g., between 0.35 and 4.00 percent), and require all stocks in the portfolios 170 to have large market capitalizations, among other possible constraints. As such, the best portfolio among the potentially feasible portfolios that satisfy the constraints may then be chosen for a current rebalance period and then re-evaluated in a next rebalance period to construct and rebalance a stock portfolio 170 that can consistently outperform target benchmarks on a risk adjusted and non-risk adjusted basis.

In one implementation, although the description that will be provided herein may specifically relate to techniques that may be used to construct portfolios 170, the same or substantially similar techniques may have applications in various other contexts. In particular, effective network construction typically raises problems that relate to calculating minimum numbers of nodes and pipes that will transport all required data or other information to customers associated with the network, and commodity networks tend to be faced with similar problems relating to minimum configurations needed to ensure that every customer will be properly served (e.g., determining the minimum configuration needed to maintain data availability if a critical network switch fails, maintain water supply to a maximum number of users in a utility network if a large water main breaks, etc.). As such, in one implementation, the system 100 may employ a minimum cut or related solution to enforce the above-described turnover constraint, and the same or a substantially similar minimum cut or related solution may be used to determine minimum configurations to ensure maximum availability in any suitable network constructed to transport data or commodities. In a related context, the same or substantially similar techniques used in the system 100 to construct the stock portfolios 170 may be applied to network security. For example, security threats may require isolating an internal network (or a portion thereof) from external networks or another portion associated with the internal network to secure the network from potential attacks or infection, in which case the same or a substantially similar minimum cut solution may be used to minimize network disruption until efforts to diagnose and resolve the potential attacks or infection have completed. As such, the mathematics embedded in the multi-objective evolutionary algorithm 150 may generally be applied to find the best feasible solution sets very quickly, while substantially reducing or eliminating the efforts that would otherwise typically be needed to search significant portions in the possible solution space. Accordingly, the substantial reduction in the time needed to search the possible solution space may have significant applicability to other contexts, and may allow real-time use of the multi-objective evolutionary algorithm 150 in many instances.

In one implementation, the system 100 shown in FIG. 1 may include one or more data repositories 110 that include security data used to construct the target stock portfolios 170, which may include a large stock index 170 benchmarked against the S&P 500 index, a large growth index 170 benchmarked against the Russell 3000 Growth index, or other suitable indices or portfolios 170 that may be appropriately benchmarked against comparable indices. In one implementation, the security data in the data repositories 110 may include data associated with one or more multi-factor models that evaluate various fundamentals associated with a stock to produce a score or recommendation associated with the stock. For example, the fundamentals evaluated in the multi-factor models may include price to earnings ratios, price-to-book ratios, cash flow, or any other suitable metric that can be evaluated to produce an overall score that underlies a stock recommendation (e.g., buy or outperform recommendations that indicate stocks having good potential, sell or underperform recommendations that indicate stocks having bad potential, etc.). As such, the security data in the data repositories 110 may include the historical scores produced with the multi-factor models, which may be organized or otherwise delimited according to appropriate time periods (e.g., based on quarterly or monthly financial statements). In one implementation, the system 100 may therefore include a data preparation engine 120 to analyze the security data contained in the data repositories 110 and prepare a rebalance list to construct and evaluate the portfolios 170 on a yearly, quarterly, monthly, or other suitable basis.

In one implementation, the data preparation engine 120 may analyze the security data in the data repositories 110 to obtain candidate constituent data to seed the particular stock portfolio 170 under construction. For example, to construct or evaluate a particular portfolio 170, the data preparation engine 120 may search the data repositories 110 to obtain the multi-factor model scores associated with the constituents in the target benchmark index, which may generally provide seed data to identify candidate constituents to include in the portfolio 170. In particular, the multi-factor model scores may generally represent forward-looking forecasts, which may be used to seed the candidate constituents and produce the portfolio 170 in a predictive manner. Furthermore, to standardize the inputs used to produce the portfolio, the data preparation engine 120 may eliminate any lines in the security data that are empty, have duplicate entries, lack multi-factor model scores, or lack any other necessary data that may be deemed appropriate. In one implementation, the data preparation engine 120 may then prepare the rebalance list, which may be provided to a rebalance engine 130.

In particular, the rebalance engine 130 may construct and evaluate the portfolios 170 yearly, quarterly, monthly, or according to another rebalance interval using the rebalance list provided from the data preparation engine 120. For example, as noted above, the rebalance list may generally include the constituents associated with the target benchmark, which may provide a candidate constituent set that represents the candidate securities to include in the portfolio 170 associated with the current rebalance. As such, the rebalance engine 130 may initially load the candidate constituent set from the rebalance list that the data preparation engine 120 provides and then invoke a candidate constituent engine 140 that removes any candidate constituents that can be excluded from the portfolio 170 on an a priori basis (e.g., due to a failure to satisfy the goals or other constraints associated with the portfolio 170). For example, in one implementation, the candidate constituent engine 140 may initially remove any stocks in the candidate constituent set having multi-factor scores under a certain threshold to eliminate stocks that have poor or marginal potential (e.g., any scores associated with sell, strong sell, underperform, or similar recommendations). In one implementation, the candidate constituent engine 140 may then rank any stocks that remain in the candidate constituent set according to market capitalization, wherein a certain percentage of the remaining stocks that have the lowest market capitalizations may be eliminated (e.g., market capitalizations in the bottom twelve percent may be eliminated to limit the stocks in the portfolio 170 to large caps). The candidate constituent engine 140 may then calculate an aggregate market capitalization associated with the remaining stocks to determine a market capitalization floor associated with the portfolio 170 (e.g., the floor may be $750M if the aggregate market capitalization exceeds $750M, otherwise the aggregate market capitalization may provide the floor). Furthermore, constituents may also be excluded due to failure to fit or otherwise satisfy certain constraints on the portfolio 170 (e.g., if the constraints require the portfolio 170 to be growth or value oriented, any constituents that are not growth or value oriented may be excluded).

In one implementation, in response to removing the candidate constituents that can be excluded a priori, the candidate constituent engine 140 may retrieve daily price data associated with the remaining candidate constituents. For example, relative to a date associated with the current rebalance, the retrieved daily price data may include a prior two-hundred and eighty-seven observations based on a maximum dimensionality that constrains subsequent mean variance optimization calculations that will be described in further detail below. Furthermore, the retrieved daily price data may include a next sixty-three observations (i.e., daily observations in a next three-month period) to calculate performance metrics associated with the portfolio 170 in the next rebalance. In one implementation, the candidate constituent engine 140 may then calculate the average market capitalization and average price-to-book score associated with the constituents in the target benchmark index. For example, the candidate constituent engine 140 may identify the CUSIP (Committee on Uniform Security Identification Procedures) number associated with each stock in the target constituents and search the current rebalance list to obtain the average market capitalization and price-to-book score associated with each CUSIP number. In particular, all constituents associated with the target benchmark may not appear in the current rebalance list due to the above-described filtering processes, whereby the candidate constituent engine 140 may calculate the average market capitalization and average price-to-book score associated with the target benchmark constituents that overlap with the current rebalance list. In one implementation, the candidate constituent engine 140 may then eliminate any remaining candidate constituents that have insufficient daily price data leading up to the current rebalance date (i.e., because stocks having missing substantial data points may interfere with the subsequent mean variance optimization calculations). For example, in one implementation, the candidate constituent engine 140 may eliminate any candidate constituents having less than seventy-five percent of the daily price data points leading up to the current rebalance date.

In one implementation, the remaining candidate constituents in the rebalance list may then be input to and analyzed with a multi-objective evolutionary algorithm 150, which may generally apply meta-heuristics to solve multi-objective optimization problems. For example, multi-objective optimization (or programming) generally refers to simultaneously optimizing two or more conflicting objectives subject to certain constraints or trade-offs. Typically, while attempting to identify solutions to a non-trivial multi-objective problem, the optimization process will reach a point where attempting to further improve one objective will cause one or more other objectives to suffer or worsen, wherein a proposed solution may be called non-dominated, Pareto optimal, or Pareto efficient if the proposed solution cannot be replaced with another proposed solution that improves one or more objectives without worsening any other objectives. Multi-objective optimization problems are thus typically configured to identify such non-dominated (or Pareto optimal or Pareto efficient) solutions and quantify the trade-offs relating to how the different optimization objectives were satisfied. In this context, the multi-objective evolutionary algorithm 150 may generally may include an object-oriented framework that can apply Pareto-based ranking schemes to compute an optimized portfolio solution set that approximates an entire Pareto frontier in order to solve multi-objective optimization problems. For example, in one implementation, the object-oriented framework associated with the multi-objective evolutionary algorithm 150 may include the jMetal Java-based framework described in “The jMetal Framework for Multi-Objective Optimization: Design and Architecture,” the contents of which are hereby incorporated by reference in their entirety. In one implementation, as will be described in further detail herein, the optimized portfolio solution set may include various portfolios 170 with different subsets from the remaining candidate constituents input to the multi-objective evolutionary algorithm 150. As will be described in further detail herein, the optimized portfolio solution set may then be examined during the subsequent mean variance optimization calculations, which may also be (or include) a multi-objective evolutionary algorithm.

In one implementation, the multi-objective evolutionary algorithm 150 may be configured to constrain how many portfolios 170 will be included in the solution set to reduce the processing time needed to examine the solution set (e.g., fifty or less), and may be further configured to require every portfolio in the solution set have a number of candidate constituents in a certain range (e.g., between twenty-five and two-hundred and fifty-six). Furthermore, to invoke the multi-objective evolutionary algorithm 150, the candidate constituent engine 140 may pass the candidate constituent data associated with the current rebalance, constituents associated with the portfolio 170 in one or more previous rebalances, the market capitalization associated with the target benchmark index, and population, generations, and mutation rate variables. Furthermore, if the current rebalance relates to a large-cap growth portfolio 170, the candidate constituent engine 140 may further pass the average price-to-book score associated with the target benchmark index to the multi-objective evolutionary algorithm 150. In one implementation, the multi-objective evolutionary algorithm 150 may be modeled on the non-dominated sorting genetic algorithm II (NSGA-II), which uses single point crossover, bit flip mutation, and binary tournament selection to solve constrained multi-objective problems. In one implementation, further detail relating to NSGA-II may be provided in “A Fast and Elitist Multiobjective Genetic Algorithm: NSGA-II,” the contents of which are hereby incorporated by reference in their entirety. As such, using the model based on NSGA-II, the population variable may generally represent the number of proposed solutions that will be carried from generation to generation, although the number of non-dominated solutions may often be considerably smaller than the population variable (e.g., because the number of proposed solutions carried from generation to generation may include dominated solutions in addition to non-dominated solutions). Further, the generations parameter may represent the number of generations that the multi-objective evolutionary algorithm 150 will evaluate, while the mutation rate variable may indicate the rate at which a solution relating to a dominated portfolio 170 will be modified from generation to generation.

In one implementation, a value associated with the generations variable may be one thousand two-hundred, while a value associated with the mutation rate variable may be 0.03 (i.e., three percent). However, the population variable may have a values that depends on whether the portfolio 170 associated with the current rebalance relates to the large-cap stock portfolio 170 or the large-cap growth portfolio 170. For example, the value associated with the population variable may be five-hundred in the large-cap stock portfolio 170, while the value associated with the population variable may be fifty in the large-cap growth portfolio 170. The difference in the value associated with the population variable may reflect that the large-cap growth portfolio 170 has an additional parameter (i.e., the average price-to-book score associated with the target benchmark index), wherein the large-cap stock portfolio 170 may have a larger population because the fewer objectives may result in the population having substantial non-dominated solutions. Accordingly, the value associated with the population variable may be lower in the large-cap growth portfolio 170 to prevent the multi-objective evolutionary algorithm 150 from generating more solutions than the subsequent mean variance optimization calculations can suitably explore. Furthermore, in one implementation, the value associated with the population variable, the value associated with the generations variable, the value associated with the mutation rate variable, the crossover type, the mutation type, and the selection method may be established by the programmer or another suitable user to configure the multi-objective evolutionary algorithm 150.

In one implementation, in response to establishing the population, generations, and mutation rate variables, the multi-objective evolutionary algorithm 150 may then determine a current rebalance number and appropriately seed the portfolios 170 in the population associated with the current rebalance with various candidate constituents depending on the current rebalance number. For example, if the current rebalance number has a zero value (i.e., there has not been a previous rebalance), the population in the zero-th generation rebalance may be seeded with various random portfolios 170 that include candidate constituents randomly selected from the rebalance list (e.g., one-hundred and fifty-six equities selected from the candidate constituents passed from the candidate constituent engine 140). However, if the current rebalance number has a non-zero value (i.e., there has been a previous rebalance, which would have created one or more “good” portfolios 170), one or more portfolios 170 from the previous rebalance may be used to seed the population in the current rebalance in addition to a sufficient number of random portfolios to suitably fill the population.

In one implementation, the multi-objective evolutionary algorithm 150 may then be executed on the seeded population in the current rebalance, wherein the multiple objectives may depend on whether the portfolio 170 associated with the current rebalance relates to the large-cap stock portfolio 170 or the large-cap growth portfolio 170. For example, in both cases, the objectives may include the maximizing the average multi-factor scores and market capitalizations associated with the candidate constituents seeded into the current rebalance population. Furthermore, if the current rebalance relates to the large-cap growth portfolio 170, the objectives may further include minimizing the average price-to-book score associated with the candidate constituents seeded into the current rebalance population. As such, the multi-objective evolutionary algorithm 150 may execute on the seeded population in the current rebalance to identify one or more portfolios 170 in the seeded population having candidate constituents that maximize the average multi-factor scores and market capitalizations, and that further minimize the average price-to-book score (if the current rebalance relates to the large-cap growth portfolio 170).

In one implementation, the multi-objective evolutionary algorithm 150 may then analyze the one or more portfolios 170 identified in the seeded population to enforce one or more penalties associated with the portfolio solution set. For example, the penalties may include a cardinality constraint that requires every portfolio 170 in the solution set have a number of candidate constituents in a certain range, whereby the penalties may cause the multi-objective evolutionary algorithm 150 to reduce a fitness score associated with any portfolios 170 having more candidate constituents than the maximum value in the range and/or less candidate constituents than the minimum value in the range and thereby reduce a likelihood that such portfolios 170 will move to subsequent generations in the multi-objective evolutionary algorithm. Moreover, if the current rebalance relates to the large-cap growth portfolio 170, the penalties may cause the multi-objective evolutionary algorithm 150 to reduce a score associated with any portfolios 170 in the solution set having average price-to-book scores that exceed the average price-to-book score associated with the target benchmark index passed from the candidate constituent engine 140. For example, the multi-objective evolutionary algorithm 150 may generally score the fitness associated with the portfolios 170 in the solution set to represent how well the portfolios 170 satisfy (or fail to satisfy) the relevant constraints, whereby the penalties may be appropriately assessed to reduce the fitness scores associated with any portfolios 170 that violate one or more constraints. In this context, the “evolution” metaphor may generally mean that rather from “eliminating” any portfolios 170 outright, a portfolio 170 having a poor fitness score will be less likely to “reproduce” (i.e., move on to the next rebalance generation).

In one implementation, in response to executing the multi-objective evolutionary algorithm 150 on the seeded population in the current rebalance, enforcing the appropriate penalties, and identifying the portfolios 170 to include in the solution set associated with the current rebalance, the multi-objective evolutionary algorithm 150 may then produce two files that represent the output associated with the current rebalance. In particular, one file may contain the objective values associated with the solution set, which include the average multi-factor scores and market capitalizations associated with the portfolios 170 in the solution set, and if the current rebalance relates to the large-cap growth portfolio 170, the average price-to-book scores. Furthermore, the other file may contain the portfolios 170 in the solution set and a binary value (i.e., zero or one) associated with each candidate constituent in the portfolios 170 associated with the solution set. For example, in one implementation, the binary value may describe a Pareto frontier that represents the Pareto efficient candidate constituents. In particular, Pareto efficiency generally relates to an economic concept that has engineering and mathematical applications, in which changing an initial allocation among a set to a different allocation may be considered a “Pareto improvement” if the change makes one or more elements in the set better off without making any elements in the set worse off. In this context, a particular allocation may be considered “Pareto efficient” if no additional Pareto improvements can be achieved from further changes to the allocation. As such, the binary value describing the Pareto efficient frontier associated with the candidate constituents in a particular portfolio 170 may indicate whether the individual candidate constituents can be allocated differently to improve one or more objective values associated with the portfolio 170 without worsening any other objective value associated therewith. In one implementation, further details relating to determining the Pareto efficient frontier may be described in “Statistical Dominance Over Pareto Optimal Mean-variance Portfolios,” the contents of which are hereby incorporated by reference in their entirety.

In one implementation, if the current rebalance number has a non-zero value (i.e., one or more portfolios 170 passed the appropriate constraints in the previous rebalance), the multi-objective evolutionary algorithm 150 may then add the one or more portfolios 170 that passed the constraints in the previous rebalance to the solution set associated with the current rebalance. Further, CUSIP numbers associated with the constituents in the prior rebalance solution set may be compared to CUSIP numbers associated with the candidate constituents in the current rebalance solution set, wherein any constituents in the previous rebalance having CUSIP numbers that are not available in the current rebalance may be eliminated. As such, in one implementation, the multi-objective evolutionary algorithm 150 may then be re-run on the portfolios 170 in the current rebalance solution set combined with the portfolios 170 passing the constraints in the prior rebalance if the current rebalance number has a non-zero value. In this manner, the portfolios 170 in the solution sets associated with the current rebalance and the prior rebalance may be tested against one another, whereby the final solution set that the multi-objective evolutionary algorithm 150 produces in the current rebalance may include the best portfolios 170 identified from the combined prior and current rebalance solution sets. In one implementation, the multi-objective evolutionary algorithm 150 may then invoke an optimization engine 160 to perform the mean variance optimization calculations noted above.

For example, in one implementation, the optimization engine 160 may be either a standard non-linear optimizer, or alternatively a multi-objective evolutionary algorithm 150 that can optimize the solution set with the potentially feasible portfolios 170, as appropriate. In one implementation, the optimization engine 160 initially calculate daily returns associated with all candidate constituents that appear in the portfolio solution set to prepare the mean variance optimization calculations. In particular, the optimization engine 160 calculates the daily returns associated with the candidate constituents that appear in the portfolio solution set to avoid potentially having to recalculating the daily return series associated with any candidate constituent multiple times. Further, in one implementation, the optimization engine 160 may retrieve the daily risk free rate closest to the date associated with the current rebalance, which may be used to calculate the Sharpe Ratio that measures the risk premium associated with the multi-factor model used in the system 100. For example, in one implementation, the retrieved daily risk free rate may include the three-month T-bill rate, which the optimization engine 160 may obtain from the Federal Reserve (e.g., via a data feed to the Federal Reserve website, available at research.stlouisfed.org/fred2/categories/116).

In one implementation, in response to calculating the daily returns associated with the candidate constituents that may appear in the portfolio solution set and retrieving the daily risk free rate closest to the current rebalance date, the optimization engine 160 may then run the mean variance optimization calculations on each portfolio in the solution set produced with the multi-objective evolutionary algorithm 150. In particular, the optimization engine 160 may identify the candidate constituents in a current portfolio and form a covariance matrix that represents returns on the identified candidate constituents in the current portfolio. In one implementation, the covariance matrix may include, at a minimum, one-hundred and twenty-six daily returns (i.e., six-months) to meet dimensionality constraints that require the covariance matrix to have more observations than candidate constituents. Furthermore, the dimensionality constraints may limit the maximum daily returns that the covariance matrix can include according to the size associated with the portfolio, whereby the covariance matrix may include, at a maximum, two-hundred and eighty-seven daily returns. In one implementation, the optimization engine 160 may form and constrain the covariance matrix using the fPortfolio library, a third-party add-in to the R statistical language. Further detail relating to the fPortfolio library may be found in “Rmetrics—Portfolio Selection and Optimization,” while further detail relating to the R statistical language may be found at cran.r-project.org, the contents of which are hereby incorporated by reference in their entirety.

In one implementation, the optimization engine 160 may then compute a tangency portfolio that represents a minimum risk portfolio having a highest risk-to-return ratio on the Pareto efficient frontier associated with the current portfolio. For example, the optimization engine 160 may compute the tangency portfolio using a tangencyPorfolio function in the fPortfolio library, or alternatively run the multi-objective evolutionary algorithm 150 to calculate a Pareto efficient frontier set and select the tangency portfolio therefrom. In the former case, the optimization engine 160 may compute the tangency portfolio using default settings in the fPortfolio specification and establish minimum and maximum weights to constrain the tangency portfolio. For example, the minimum weight may be 0.0035 and the maximum weight may be 0.04 to reflect the minimum and maximum allocations associated with the candidate constituents in the portfolio. As such, the minimum and maximum weights may further provide de facto cardinality constraints that force each candidate constituent to have at least the minimum weight allocation and no more than the maximum weight allocation. However, because the fPortfolio library lacks a mechanism to specify a zero OR minimum non-zero weight, the optimization engine 160 may use the alternate approach in response to determining that the zero OR minimum non-zero weight constraint may be needed (i.e., the multi-objective evolutionary algorithm 150 may be run to calculate the Pareto efficient frontier set and select the tangency portfolio). Although the approach using the multi-objective evolutionary algorithm 150 may provide flexibility in enabling the minimum weight to be zero or a threshold non-zero value, using the multi-objective evolutionary algorithm 150 may add objectives relating to return and risk and thereby make the mean variance optimization calculations more time consuming than fPortfolio (e.g., typically one order of magnitude).

In one implementation, if the mean variance optimization calculations using fPortfolio or the multi-objective evolutionary algorithm 150 fail to suitably compute the tangency portfolio, the optimization engine 160 may then terminate processing the current portfolio and use null values to represent a result associated with the current tangency portfolio. Otherwise, if the mean variance optimization calculations successfully computed the tangency portfolio, the optimization engine 160 may calculate a turnover associated with the tangency portfolio, which may generally represent a shift in weight between the portfolio in the prior rebalance and the (weighted) tangency portfolio in the current rebalance. In particular, in response to the optimization engine 160 determining that the calculated turnover exceeds a threshold value (e.g., twenty-four percent per quarter), the optimization engine 160 may then shift the weights associated with the portfolio from the candidate constituents selected with the mean variance optimization calculations to the constituents that the portfolio held in the prior rebalance. For example, to shift the weights associated with the portfolio, the optimization engine 160 may initially identify the candidate constituents in the current portfolio that have been weighted and sort the identified candidate constituents in an ascending weight order. In one implementation, the optimization engine 160 may then identify the weighted constituents in the prior rebalance portfolio similarly sort the weighted constituents in the prior portfolio according to ascending weights. The optimization engine 160 may then remove all weighted constituents in the prior portfolio that either overlap with the weighted candidate constituents in the current portfolio or do not appear in any portfolio associated with the current rebalance.

In one implementation, in response to removing the weighted constituents in the prior portfolio that overlap with the weighted candidate constituents in the current portfolio or do not appear in the current rebalance solution set, the optimization engine 160 may designate the remaining weighted constituents in the prior portfolio “swap candidates.” The weight associated with each candidate constituent in the ordered current portfolio that was not weighted in the prior portfolio may then be shifted to one of the swap candidates. The optimization engine 160 may then recalculate the turnover with the weights shifted to the swap candidates and determine whether the recalculated turnover has a value below the threshold, in which case the optimization engine 160 may terminate shifting the weights and save the calculated values and weights associated with the optimized current portfolio. On the other hand, if the recalculated turnover value continues to equal or exceed the threshold value, the optimization engine 160 may iteratively shift the weights assigned to the candidate constituents in the ordered current portfolio to the swap candidates until the turnover value does not equal or exceed the threshold value or no further swap candidates remain. In one implementation, an alternative approach may only shift the weights associated with the candidate constituents having the minimum weight (i.e., 0.35 percent) to the swap candidates.

In one implementation, in response to completing the mean variance optimization calculations on all portfolios in the current solution set, the optimization engine 160 may then select the winning portfolio associated with the current solution set. For example, in one implementation, the winning portfolio may include the portfolio that passed the turnover and market capitalization constraints while having the best Sharpe ratio among the portfolios that passed the constraints. However, if no portfolios in the current solution set passed the turnover and market capitalization constraints, the winning portfolio may be the portfolio that has the best turnover value. In either case, the rebalance engine 130 may calculate and log the performance associated with the winning portfolio and the target benchmark index over the period between the dates associated with the current rebalance and the next rebalance and continue with similar rebalancing techniques when the next rebalance date arises.

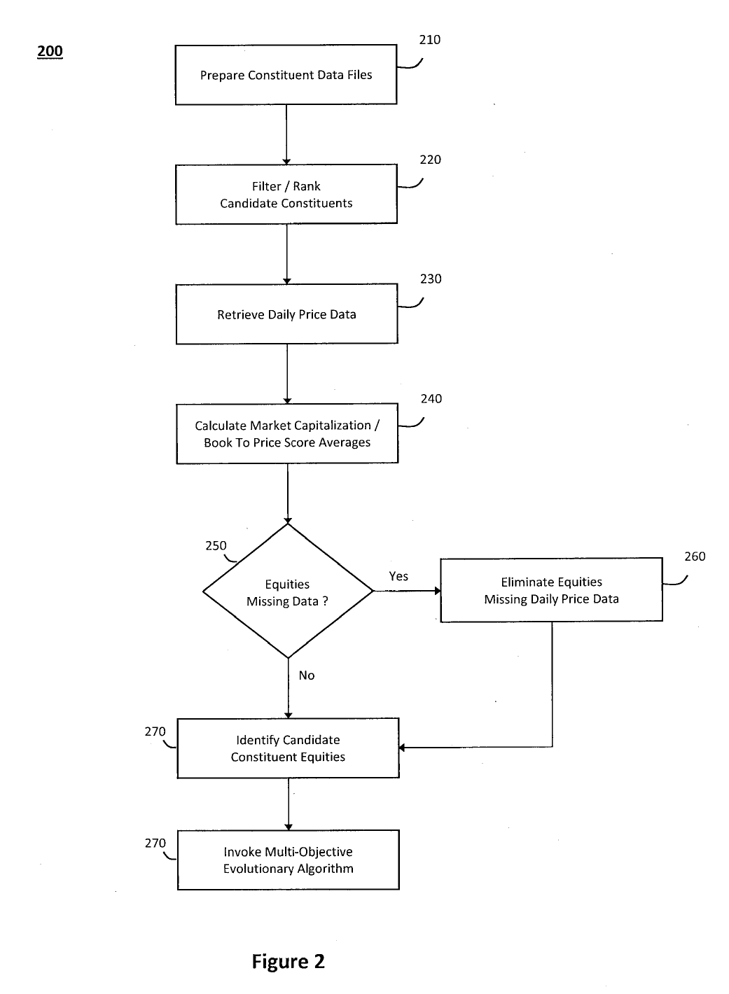

According to one aspect of the invention, FIG. 2 illustrates an exemplary method 200 to load, retrieve, and filter input data that may be used to construct portfolios. In particular, the method 200 illustrated in FIG. 2 may generally initialize a multi-factor stock model to build a stock portfolio, which may include a large-cap portfolio, a growth portfolio, or any other suitable portfolio. In one implementation, the method 200 may include various operations to select candidate constituents to include in the portfolio and maximize the geometric mean, Sharpe Ratio, and Information Ratio associated therewith. Additionally, the method 200 may apply one or more constraints to limit the candidate constituents that will subsequently be examined to construct the portfolio.

For example, in one implementation, an operation 210 may include preparing one or more constituent data files using security data stored in one or more data repositories. In particular, the security data may generally include output from one or more multi-factor models used to evaluate price to earnings ratios, price-to-book ratios, cash flow, or other stock fundamentals and produce a score or recommendation associated with a stock. As such, the security data used to prepare the constituent data files in operation 210 may include historical scores that the multi-factor models produced, which may be organized or otherwise delimited according to yearly, quarterly, monthly, or other intervals. In one implementation, operation 210 may therefore include analyzing the security data in the data repositories to prepare a rebalance list that contains a candidate constituent set to be used in constructing and evaluating the portfolio on a yearly, quarterly, monthly, or other suitable basis. In one implementation, to prepare the candidate constituent data files that will seed the portfolio under construction, a data preparation engine may search the data repositories to obtain the multi-factor model scores associated with various constituents in a target benchmark index, wherein the target benchmark constituents may seed the candidate constituent data files to construct the portfolio. For example, to standardize the candidate constituent data files that represent the inputs that will be used to construct the portfolio, operation 210 may eliminate any lines in the candidate constituent data files without multi-factor model scores or other necessary data that may be deemed appropriate.

In one implementation, the data preparation engine may then prepare a rebalance list, wherein an operation 220 may include analyzing the rebalance list to remove any candidate constituents that can be excluded from the portfolio on an a priori basis. In particular, operation 220 may initially remove any stocks in the candidate constituent set having multi-factor scores under a certain threshold to eliminate stocks that have poor or marginal potential. In one implementation, operation 220 may then include ranking any remaining stocks in the candidate constituent set according to market capitalization and eliminating a certain percentage of the remaining stocks that have the lowest market capitalizations. In one implementation, in response to removing the candidate constituents that can be excluded a priori, an operation 230 may include retrieving daily price data associated with the remaining candidate constituents. For example, relative to a date associated with the current rebalance, the retrieved daily price data may include a prior two-hundred and eighty-seven observations to be used in subsequent mean variance optimization calculations, and may further include a subsequent sixty-three observations to calculate the performance associated with the portfolio in the next rebalance. However, the number of prior and subsequent observations retrieved in operation 230 may vary depending on the goals and constraints associated with the portfolio.

In one implementation, the average market capitalization and average price-to-book score associated with the constituents in the target benchmark index may then be calculated in an operation 240. For example, operation 240 may include identifying the CUSIP number associated with each constituent stock in the target benchmark index and searching the current rebalance list to obtain the average market capitalization and price-to-book score associated with each target benchmark constituent having a CUSIP number that appears in the current rebalance list. In particular, all constituents in the target benchmark may not appear in the current rebalance list due to the filtering and ranking processes performed in operations 210 and 220, whereby the average market capitalization and average price-to-book score calculated in operation 240 may include the target benchmark constituents that overlap with the current rebalance list. In one implementation, an operation 250 may then determine whether any remaining candidate constituents have insufficient daily price data leading up to the current rebalance date (e.g., less than seventy-five percent of the daily price data points leading up to the current rebalance date). In particular, because stocks having missing substantial data points may interfere with the subsequent mean variance optimization calculations, operation 250 may identify any remaining candidate constituents have insufficient daily price data to ensure that all candidate constituents used to seed the portfolio will have sufficient daily price data to enable the subsequent mean variance optimization calculations. As such, in response to identifying any remaining candidate constituents having insufficient daily price data leading up to the current rebalance date, an operation 260 may include removing the identified candidate constituents from the candidate constituent set. Alternatively, if the remaining candidate constituents all have sufficient daily price data leading up to the current rebalance date, operation 260 may be bypassed. In either case, the candidate constituents that remain following operations 250 and/or 260 may represent the stocks or other equities to include in a candidate constituent set created or otherwise identified in an operation 270. In one implementation, the candidate constituent set may be input to a multi-objective evolutionary algorithm, which may be invoked in an operation 280 to identify a portfolio solution set that will be examined during the subsequent mean variance optimization calculations.

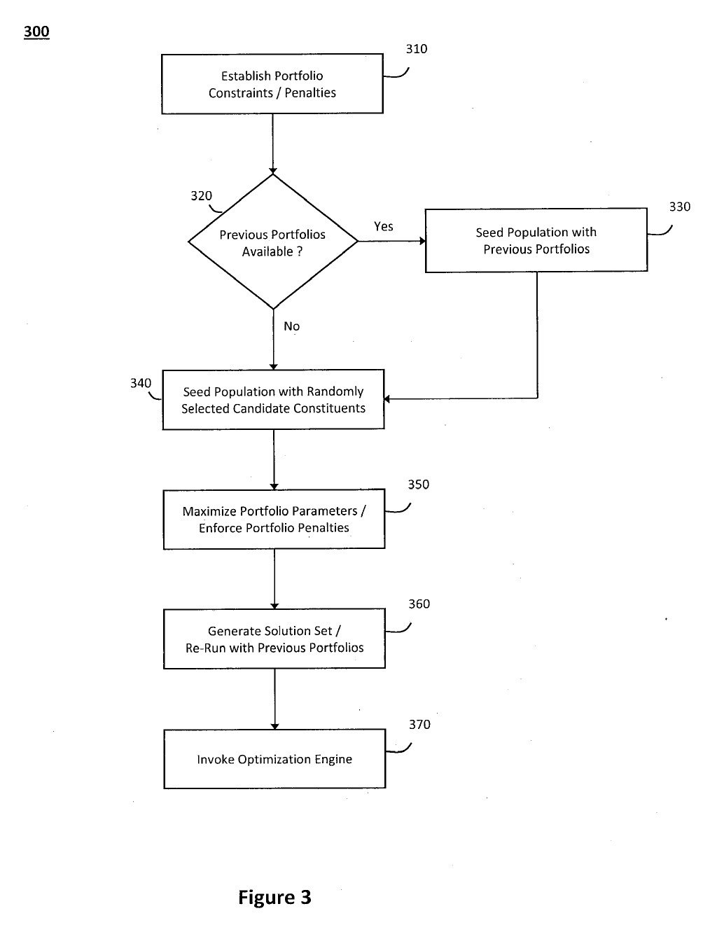

According to one aspect of the invention, FIG. 3 illustrates an exemplary method 300 to derive a candidate portfolio solution set using a multi-objective evolutionary algorithm. In particular, the method 300 illustrated in FIG. 3 may generally be performed in response to a candidate constituent engine passing a candidate constituent set in addition to one or more other variables or parameters to the multi-objective evolutionary algorithm, which may operate in association with an object-oriented framework that applies meta-heuristics to solve a multi-objective optimization problem that relates to identifying the portfolio solution set that will be examined during subsequent mean variance optimization calculations. For example, in one implementation, the solution set that the method 300 identifies with the multi-objective evolutionary algorithm may generally include various portfolios with different subsets from the remaining candidate constituents that the candidate constituent engine passes to the multi-objective evolutionary algorithm.

As such, an operation 310 may include initializing the multi-objective evolutionary algorithm to establish one or more constraints and penalties associated with the portfolios to include in the solution set. In one implementation, the constraints and penalties may include a cardinality associated with the solution set (i.e., how many portfolios can be properly included in the solution set) and a cardinality associated with the portfolios that are included in the solution set (i.e., how many candidate constituents can be properly included in the portfolios). For example, in one implementation, the cardinality associated with the solution set may require that the solution set include fifty or fewer portfolios, while the cardinality associated with the portfolios set may require every portfolio have between twenty-five and two-hundred and fifty-six candidate constituents. Additionally, in one implementation, if the multi-objective evolutionary algorithm was invoked to create or rebalance a large-cap growth portfolio, the constraints and penalties may further require that every portfolio in the solution set have an average price-to-book score less than or equal to an average price-to-book score associated with the constituents in a target benchmark index passed from the candidate constituent engine. In one implementation, in addition to the cardinality and price-to-book constraints and penalties, operation 310 may further establish the relevant multi-objective variables and other inputs that the multi-objective evolutionary algorithm will use to identify the portfolios in the solution set. In particular, operation 310 may further include the candidate constituent engine passing the candidate constituent set associated with the current rebalance, a market capitalization associated with the target benchmark index that will be compared to the portfolios in the solution set, Furthermore, if the multi-objective evolutionary algorithm was invoked to create or rebalance the large-cap growth portfolio, the candidate constituent engine may further pass the average price-to-book score associated with the target benchmark index to the multi-objective evolutionary algorithm in operation 310.

Furthermore, in one implementation, the constraints established in operation 310 may include population, generations, and mutation rate variables that control the multi-objective evolutionary algorithm. In particular, as noted above, the multi-objective evolutionary algorithm may use single point crossover, bit flip mutation, and binary tournament selection to solve the constrained multi-objective problem and thereby identify the portfolio solution set, wherein the multi-objective problem may be constrained with the population variable to represent how many proposed solutions will be carried from one generation to the next, the generations parameter to represent how many solution set generations the multi-objective evolutionary algorithm will evaluate, and the mutation rate variable to indicate the rate at which a solution relating to a dominated portfolio can be modified from one generation to the next. For example, the generations variable may have a one thousand two-hundred value and the mutation rate variable may have a three percent value, while the population variable may have a values that depends on whether or not the multi-objective evolutionary algorithm was invoked to create or rebalance the large-cap growth portfolio. In particular, because the large-cap growth portfolio has an additional parameter in the average price-to-book score associated with the target benchmark index, the large-cap growth portfolio may have a smaller populations value because the additional objective may result in the solution set having minimal non-dominated solutions (i.e., the smaller populations value may prevent the multi-objective evolutionary algorithm from generating more solutions that the subsequent mean variance optimization calculations can suitably explore). In contrast, fewer variables may result in the solution set having substantial non-dominated solutions, whereby the solution set may need additional elements to find a suitable number of dominated solutions. Accordingly, in one implementation, the population variable may be fifty in the large-cap growth portfolio and five-hundred in any other portfolios that have fewer objectives.

In one implementation, in response to establishing the constraints and penalties associated with the multi-objective evolutionary algorithm, an operation 320 may include determining a current rebalance number. In particular, if the current rebalance number has a non-zero value, there has been a prior rebalance that would have created one or more “good” portfolios to be considered in the current rebalance. As such, in response to determining that the current rebalance number has a zero value (i.e., there has not been a previous rebalance), an operation 340 may seed the population in the zero-th generation rebalance with various random portfolios that include candidate constituents randomly selected from the candidate constituent set passed in operation 310. On the other hand, in response to operation 320 resulting in a determination that the current rebalance number has a non-zero value (i.e., there has been a previous rebalance that created one or more “good” portfolios), an operation 330 may include using one or more portfolios from the prior rebalance to seed the population associated with the current rebalance prior to operation 340 seeding the population a sufficient number of random portfolios to suitably fill the population. As such, if the current rebalance number has a non-zero value, the candidate constituents seeded into the population associated with the current rebalance may include the randomly selected portfolios in addition to certain portfolios from the prior rebalance.

In one implementation, an operation 350 may then include executing the multi-objective evolutionary algorithm on the seeded population in the current rebalance to apply evolutionary pressure to maximize certain parameters and enforce certain penalties associated with identifying the solution set associated with the current rebalance. For example, in one implementation, operation 350 may attempt to identify one or more portfolios in the population associated with the current rebalance that maximize the average multi-factor scores and market capitalizations associated with the candidate constituents seeded into the current rebalance population. Furthermore, if the multi-objective evolutionary algorithm was invoked to create or rebalance the large-cap growth portfolio, operation 350 may further attempt to minimize the average price-to-book score associated with the candidate constituents seeded into the current rebalance population. As such, operation 350 may generally analyze the seeded rebalance population to identify one or more portfolios having candidate constituents that maximize the average multi-factor scores and market capitalizations (and/or minimize the average price-to-book score if creating or rebalancing the large-cap growth portfolio). Additionally, operation 350 may enforce the previously established penalties on any identified portfolios in the seeded population that violate the previously established constraints. For example, operation 350 may reduce a fitness score associated with any portfolios having more candidate constituents than the maximum value in the range and/or less candidate constituents than the minimum value in the range and thereby reduce a likelihood that such portfolios will move to subsequent generations in the multi-objective evolutionary algorithm. Further, in one implementation, operation 350 may enforce the cardinality constraint in combination, whereby any portfolios with more candidate constituents than the maximum value or less candidate constituents than the minimum value may be eliminated to meet the cardinality constraint. Moreover, if the current rebalance relates to the large-cap growth portfolio, operation 350 may reduce a score associated with any portfolios in the solution set with average price-to-book scores that exceed the average price-to-book score associated with the target benchmark index. For example, the multi-objective evolutionary algorithm may generally score the fitness associated with the portfolios in the solution set to represent how well the portfolios satisfy (or fail to satisfy) the relevant constraints, whereby the penalties may be appropriately assessed in operation 350 to reduce the fitness scores associated with any portfolios that violate one or more constraints. In this context, the “evolution” metaphor may generally mean that rather from “eliminating” any portfolios outright, a portfolio having a poor fitness score will be less likely to “reproduce” (i.e., move on to the next rebalance generation).

In one implementation, in response to maximizing and/or minimizing the parameters associated with the seeded population, appropriately enforcing the penalties, an operation 360 may generate the solution set with one or more portfolios that appropriately maximize and/or minimize the parameters and pass the constraints. For example, the solution set generated in operation 360 may generally include the objective values associated with the portfolios in the solution set, including the average multi-factor scores and market capitalizations associated with the portfolios (and/or the average price-to-book scores). In addition, the solution set generated in operation 360 may further include the portfolios to include in the solution set and binary values that describe a Pareto frontier associated with each candidate constituent in the portfolios. For example, as noted above, the Pareto frontier may generally indicate whether or not a particular candidate constituent can be considered Pareto efficient (i.e., whether individual candidate constituents in a particular portfolio can be allocated differently to improve an objective value associated with the portfolio without worsening any other objective values). Moreover, if the current rebalance number has a non-zero value, operation 360 may further include add any portfolios that passed the appropriate constraints in the prior rebalance to the current solution set, eliminate any constituents in the portfolios from the prior rebalance not appearing in the current rebalance, combine the portfolios in the current solution set with the portfolios passing the constraints in the prior rebalance, and then re-run the multi-objective evolutionary algorithm on the combined solution sets. In this manner, operation 360 may test the portfolios in the solution set associated with the current rebalance and the prior rebalance against one another, whereby the final solution set generated in operation 360 may include the best portfolios identified from the combined prior and current rebalance solution sets. In one implementation, an optimization engine may then be invoked in an operation 370 to perform the above-referenced mean variance optimization calculations.

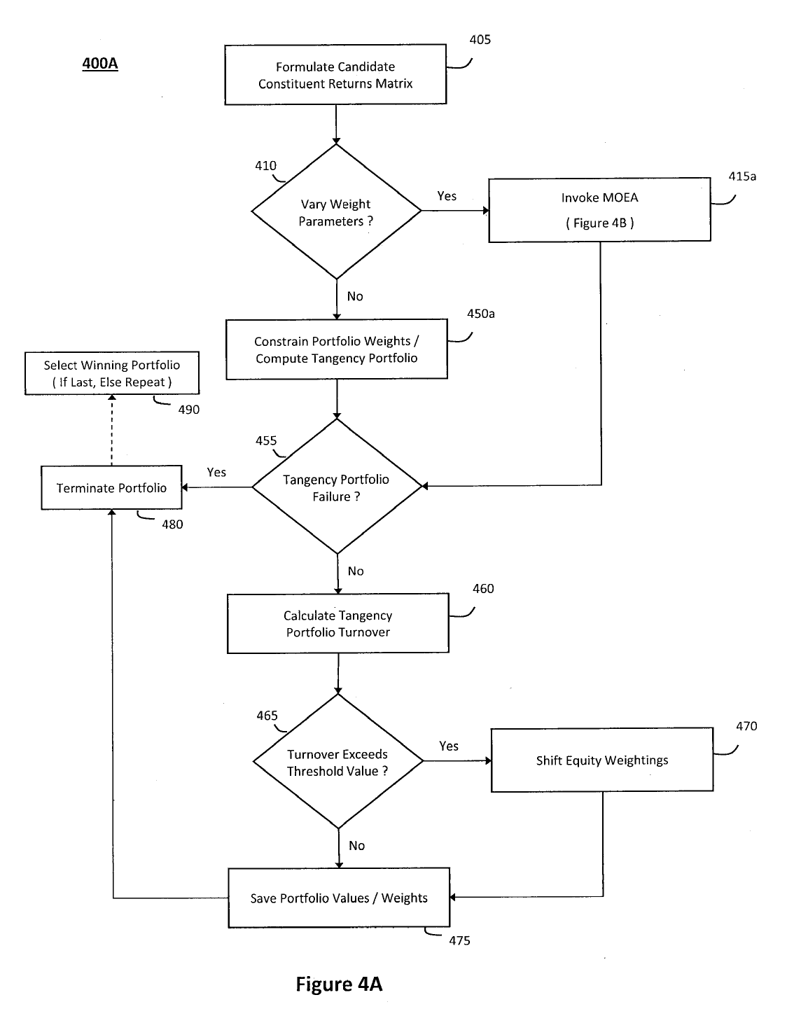

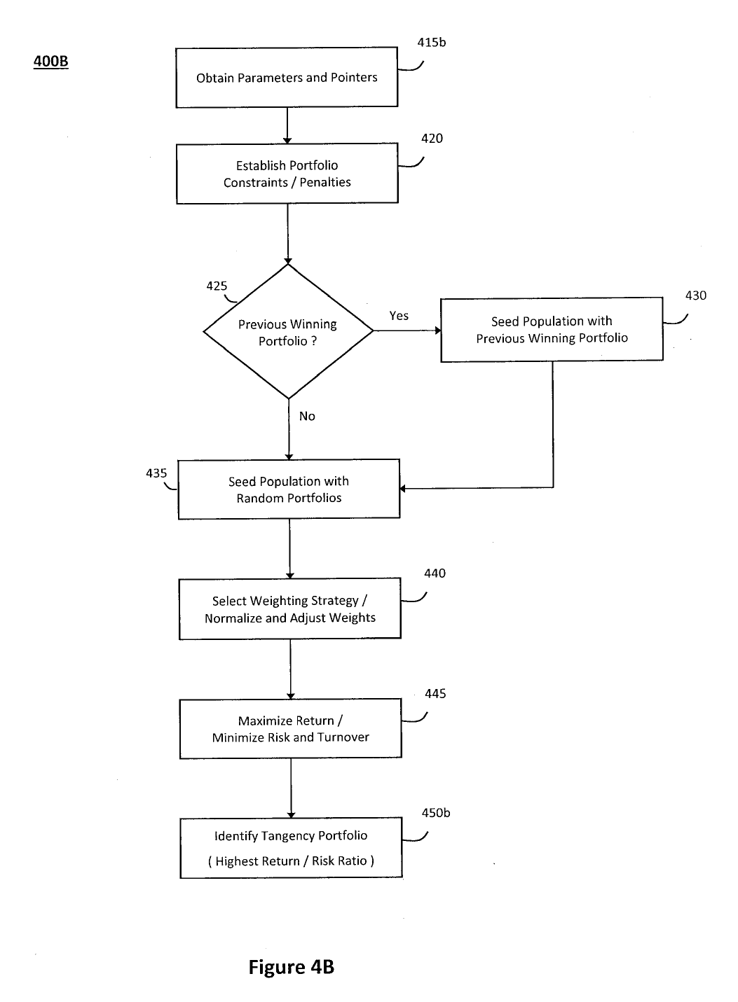

According to one aspect of the invention, FIGS. 4A-B illustrate an exemplary method 400 to examine a candidate portfolio solution set and construct an outperforming portfolio. In particular, the method 400A illustrated in FIG. 4A may generally be performed to optimize one or more proposed portfolios in a current solution set and identify a winning portfolio among the proposed portfolios. For example, in one implementation, the method 400A may include an optimization engine initially calculating daily returns associated with all candidate constituents that appear in the proposed portfolios to prepare the mean variance optimization calculations referenced above. In particular, in an operation 405, the optimization engine may calculate daily returns associated with the candidate constituents that appear in the proposed portfolios and retrieve the daily risk free rate closest to a date associated with the current rebalance solution set, wherein the daily risk free rate may be used to calculate the Sharpe Ratio that measures the risk premium associated with the multi-factor model used to construct the proposed portfolios. In one implementation, operation 405 may further include identifying the candidate constituents in a current proposed portfolio and forming a covariance matrix that represents returns on the identified candidate constituents in the current proposed portfolio. In one implementation, the covariance matrix may include, at a minimum, sufficient daily returns to meet a dimensionality constraint that requires the number of observations in the covariance matrix to exceed the number of candidate constituents. Furthermore, in one implementation, the dimensionality constraint may limit the maximum daily returns to use in the covariance matrix according to the size associated with the proposed portfolio.

In one implementation, an operation 410 may include the optimization engine determining whether to use variable weights in a tangency portfolio that represents a highest risk-to-return ratio on the Pareto efficient frontier associated with the current portfolio. For example, the optimization engine may generally use the fPortfolio library to compute the tangency portfolio, but the fPortfolio library lacks a mechanism to specify variable minimum weights (e.g., zero or a minimum non-zero threshold). Thus, in response to the optimization engine determining that the tangency portfolio may include variable weights, an operation 415a may invoke the multi-objective evolutionary algorithm to calculate the Pareto efficient frontier set and select the tangency portfolio therefrom, as will be described in further detail below with reference to FIG. 4B. Otherwise, if the optimization engine determines that the tangency portfolio will not include variable weights, an operation 450a may include constraining weights associated with the candidate constituents in the proposed portfolio and computing the tangency portfolio using the fPortfolio library. For example, operation 450a may compute the tangency portfolio using default settings in the fPortfolio specification and establish minimum and maximum weights to constrain the tangency portfolio (e.g., the minimum weight may be 0.35 percent and the maximum weight may be four percent). As such, the minimum and maximum weights may provide de facto cardinality constraints that force each candidate constituent in the proposed portfolio to have at least the minimum weight allocation and no more than the maximum weight allocation.

In one implementation, regardless of whether the fPortfolio library or the multi-objective evolutionary algorithm was used to compute the tangency portfolio, the optimization engine may determine whether the tangency portfolio failed to suitably compute in an operation 455. In response to determining that the tangency portfolio failed to compute, the optimization engine may terminate processing the current portfolio and insert null values to represent a result associated with the current portfolio in an operation 480. If the solution set includes additional proposed portfolios, the method 400A may return to 405 and initiate processing the next proposed portfolio in the solution set. Otherwise, if the current (terminated) portfolio represents the last proposed portfolio in the solution set, the optimization engine may select the winning portfolio in an operation 490, as will be described in further detail below. However, if the optimization engine determines that the tangency portfolio successfully computed in operation 455, the optimization engine may then calculate a turnover associated with the tangency portfolio in an operation 460. In particular, the calculated turnover may generally represent a shift in weight between the winning portfolio in the prior rebalance and the (weighted) tangency portfolio computed from the current proposed portfolio in the current rebalance.

In one implementation, the optimization engine may then determine whether the calculated turnover value meets or exceeds a threshold value in an operation 465, wherein the threshold value may include a certain percentage in a particular time period (e.g., twenty-four percent per quarter). In response to determining that the calculated turnover value meets or exceeds the threshold value, an operation 470 may include the optimization engine shifting the weights associated with the candidate constituents selected in the mean variance optimization calculations to the constituents held in the winning portfolio from the prior rebalance. For example, operation 470 may include the optimization engine initially identifying the candidate constituents in the current proposed portfolio that have been weighted and sort the identified candidate constituents in an ascending weight order. In one implementation, the weighted constituents in the prior rebalance portfolio may then be similarly identified and sorted according to ascending weight. In one implementation, the optimization engine may then remove all weighted candidate constituents in the current proposed portfolio from the weighted constituents in the prior winning portfolio in addition to any weighted constituents in the prior winning portfolio that do not appear in the solution set associated with the current rebalance. In response to suitably removing the weighted candidate constituents in the current portfolio and the weighted constituents in the prior winning portfolio that do not appear in the current solution set, the optimization engine may then designate the weighted constituents remaining from the prior winning portfolio “swap candidates,” wherein the weight associated with any candidate constituent in the ordered proposed portfolio that was not weighted in the prior winning portfolio may be shifted to one of the swap candidates.

In one implementation, operation 470 may further include the optimization engine then recalculating the turnover value following the shift in weights to the swap candidates and determining whether the recalculated turnover has a value below the threshold, wherein if the recalculated turnover value continues to equal or exceed the threshold value, operation 470 may iteratively shift the weights assigned to the candidate constituents in the ordered proposed portfolio to the swap candidates until the turnover value falls below the threshold value or no further swap candidates remain. As such, if the recalculated turnover value has fallen below the threshold value or no further swap candidates remain, an operation 475 may include the optimization engine terminating the weight shift and saving the calculated values and weights associated with the optimized current proposed portfolio. Similarly, in response to operation 465 resulting in a determination that the calculated turnover value does not meet or exceed the threshold value (i.e., prior to any weight shifting in operation 470), the optimization engine may save the calculated values and weights associated with the optimized current proposed portfolio without performing operation 470.

In either case, in response to suitably saving the calculated values and weights associated with the optimized current proposed portfolio in operation 475, the optimization engine may terminate the current proposed portfolio in operation 480 and iteratively perform the method 400A until the mean variance optimization calculations have been performed on all proposed portfolios in the current solution set. In response to completing the mean variance optimization calculations have been performed on all proposed portfolios in the current solution set, the optimization engine may then select the winning portfolio associated with the current solution set in operation 490. For example, in one implementation, the winning portfolio may include the proposed portfolio that passed the turnover constraint and the market capitalization constraint while having the best Sharpe ratio among the proposed portfolios that passed the constraints. However, if no proposed portfolios in the current solution set passed the turnover and market capitalization constraints, the winning portfolio selected in operation 490 may be the portfolio having the best turnover value.

In one implementation, FIG. 4A illustrates a method 400B, which may generally be invoked in response to operation 415a in FIG. 4A invoking the multi-objective evolutionary algorithm to use variable weights in computing the tangency portfolio that represents the highest risk-to-return ratio on the Pareto efficient frontier associated with the current proposed portfolio. For example, rather than using the fPortfolio library to compute the tangency portfolio, the method 400B may be used to calculate the Pareto efficient frontier set and select the tangency portfolio therefrom due to the fPortfolio library lacking a mechanism to specify zero or minimum non-zero weights. Additionally, in one implementation, the method 400B shown in FIG. 4B and described herein may be used to address the pipeline and network security problems noted above in relation to FIG. 1. In particular, the method 400B may generally solve a minimum cut solution to enforce the above-described turnover constraint, which may have the same or substantially similar applications in contexts that relate to determining minimum configurations to ensure maximum availability in any suitable network having pipelines to transport data or commodities or isolate internal networks (or portions thereof) from external networks or other portions associated with the internal networks.

In one implementation, in addition to forming the candidate constituents returns matrix (i.e., in operation 405 associated with the method 400A shown in FIG. 4A), the method 400B may include an operation 415b to obtain one or more parameters and pointers that configure the multi-objective evolutionary algorithm executed herein. For example, in one implementation, operation 415b may obtain pointers to one or more files that include mean expected returns, variances, the covariance matrix associated with the current proposed portfolio, and the previous winning portfolio. Alternatively, in one implementation, operation 415b may replace the variances and covariance matrix with a kurtosis and co-kurtosis matrix to perform a mean kurtosis optimization. In particular, the kurtosis may measure a peakedness associated with a variable probability distribution, wherein a higher kurtosis generally means that variances primarily result from infrequent extreme deviations rather than frequent moderate deviations. Further, the co-kurtosis matrix may measure a peak degree associated with a first variable probability distribution in relation to the peakedness associated with another variable, wherein a higher co-kurtosis generally means that the first variable has a flatter probability distribution than the other variable. However, computing the kurtosis and co-kurtosis matrix to perform the mean kurtosis optimization may be substantially slower than using the variances and covariance matrix, whereby whether operation 415b uses the variances and covariance matrix or the kurtosis and co-kurtosis matrix may depend on the processing infrastructure that carries out the method 400B. In one implementation, further detail relating to the kurtosis and techniques to compute the matrices based thereon may be provided in “Generalized Kurtosis and Applications in Blind Equalization of MIMO Channels,” the contents of which are hereby incorporated by reference in their entirety.

Additionally, in one implementation, one or more constraints and penalties may be established in an operation 420, wherein the constraints may include population, generations, and mutation rate variables to configure the multi-objective evolutionary algorithm. For example, in one implementation, the population variable may have a value equal to one-hundred, the generations variable may have a value equal to six-hundred, and the mutation rate variable may have a value equal to one percent (i.e., 0.01). Furthermore, in one implementation, establishing the constraints and penalties in operation 420 may include selecting a particular methodology to replicate results associated with mean variance optimization calculations using the multi-objective evolutionary algorithm. For example, in one implementation, the selected methodology may use simulated binary crossover (SBX) operators, polynomial mutation, and binary tournament selection modeled on the Strength Pareto Evolutionary Algorithm II (SPEA2) to configure the multi-objective evolutionary algorithm in a manner that may replicate the results associated with mean variance optimization calculations. Furthermore, the constraints and penalties established in operation 420 may include an archive size, which may include a value equal to the established value associated with the population variable (e.g., one-hundred). In one implementation, further detail relating to SPEA2, which may be used to find or approximate the Pareto efficient frontier set that solves the multi-objective problem addressed in the method 400B—described herein, may be provided in “SPEA2: Improving the Strength Pareto Evolutionary Algorithm,” the contents of which are hereby incorporated by reference in their entirety.

In one implementation, in response to obtaining the appropriate parameters and pointers and establishing the appropriate constraints and penalties, an operation 425 may include determining whether the pointers make the previous winning portfolio available. In one implementation, if available, the previous winning portfolio may be seeded into the current generation set in an operation 430, and the current generation set may be further seeded with one or more random portfolios in an operation 435 regardless of the availability associated with the previous winning portfolio. In one implementation, an operation 440 may then initiate evaluating the current generation set, wherein operation 440 may include randomly assigning weights to the candidate constituents associated with the portfolios seeded into the population associated with the current generation set and normalizing the randomly assigned weights (i.e., to make the randomly assigned weights have a sum that equals one). Additionally, in one implementation, operation 440 may then adjust the normalized weights using either a first weighting strategy in which one or more candidate constituents may have a zero weight, a second weighting strategy in which all candidate constituents have at least a minimum weight, or both the first weighting strategy and the second weighting strategy.

For example, in one implementation, the first weighting strategy may specify a range where non-zero weight values must be greater than or equal to a minimum value (e.g., 0.0035) and less than or equal to a maximum value (e.g., 0.04). Furthermore, to permit one or more candidate constituents to have a zero weight, the first weighting strategy may round any normalized weights having a value less than or equal to a threshold value (e.g., 0.00175) down to zero, while any normalized weights having a value greater than the threshold value may be rounded up to the minimum value in the range (e.g., 0.0035). Similarly, any normalized weights having a value greater than the maximum value in the range may be rounded down to the maximum value (e.g., 0.04). In one implementation, the second weighting strategy may specify the same or a similar range where weight values must be greater than or equal to the minimum value and less than or equal to the maximum value, except that the second weighting strategy may further specify that all candidate constituents have a weight greater than or equal to the minimum value. In other words, the second weighting strategy may round any normalized weights that are less than the minimum value in the range up to the minimum value, while any normalized weights that are greater than the maximum value in the range may be rounded down to the maximum value.

In one implementation, in response to appropriately rounding the normalizing weights, the multi-objective evolutionary algorithm may then adjust the normalized and rounded weights in an operation 445 to address various objectives that relate to maximizing and minimizing certain parameters associated with the proposed portfolio, wherein operation 445 may include the multi-objective evolutionary algorithm performing the same or substantially similar techniques in the first weighting strategy or the second weighting strategy (or both) to adjust the weights and address the objectives that relate to maximizing and minimizing the proposed portfolio parameters. In particular, operation 445 may generally include adjusting the rounded and normalized weights associated with one or more candidate constituents to maximize a return value, minimize a risk value, and minimize a turnover value associated with the proposed portfolio. For example, operation 445 may adjust the rounded and normalized weights assigned to one or more candidate constituents and add all weight adjustments to a ledger or another suitable counter. In response to completing all weight adjustments in the current proposed portfolio, the weight adjustments added to the ledger may then be debited or credited among the candidate constituents. For example, to debit or credit the weight adjustments, operation 445 may include evenly dividing the weight adjustments among any candidate constituents that can accept the debit or credit amount without moving outside the previously established weight range.

In one implementation, to perform the weight adjustments, operation 445 may perform standard mean variance optimization calculations to maximize the return value and minimize the risk value using techniques modeled on formulas described in “Investments” to Bodie et al., the contents of which are hereby incorporated by reference in their entirety. Furthermore, operation 445 may determine a shift in weight between the previous winning portfolio and the current proposed portfolio to address the objective that relates to minimizing the turnover value. In one implementation, an operation 450b may then read the objective values that include the maximized return, minimized risk, and minimized turnover and the weight-adjusted portfolios associated therewith to identify the tangency portfolio. In particular, operation 450b may identify the weight-adjusted portfolio having a highest return-to-risk ratio, which may represent the tangency portfolio. In one implementation, the tangency portfolio identified in operation 450b may then be passed back into the method shown in FIG. 4A, which may resume processing the tangency portfolio in operation 455 in the same or a substantially similar as described above in relation to FIG. 4A.

Aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What is claimed is:

1. A system for constructing outperforming portfolios relative to target benchmarks, wherein the system comprises one or more processors configured to:
establish one or more objectives to construct a portfolio that outperforms a target benchmark index having multiple constituents;
generate a rebalance list that includes one or more candidate constituents selected from the multiple constituents associated with the target benchmark, wherein the rebalance list eliminates one or more of the multiple constituents that cannot contribute to the one or more established objectives;
run a multi-objective evolutionary algorithm to analyze the one or more candidate constituents in the rebalance list and produce a solution set having multiple proposed portfolios that include candidate constituent subsets selected from the one or more candidate constituents to achieve the one or more established objectives; and
execute one or more mean variance optimization calculations to compute multiple tangency portfolios that allocate weights to the candidate constituent subsets in the multiple proposed portfolios, identify a subset of the multiple tangency portfolios that satisfy the one or more established objectives, and select one of the subset of the multiple tangency portfolios that best satisfy the one or more established objectives to be a winning portfolio.

2. The system of claim 1, wherein the one or more of the multiple constituents that cannot contribute to the one or more established objectives include any of the multiple constituents having multi-factor scores, market capitalizations, or daily price data points that fail to meet to exceed a predetermined threshold.

3. The system of claim 2, wherein the one or more established objectives include one or more of maximizing the multi-factor scores, maximizing the market capitalizations, or minimizing price-to-book scores associated with the candidate constituent subsets in the multiple proposed portfolios associated with the solution set.

4. The system of claim 1, wherein the one or more processors are further configured to:
determine whether a prior rebalance produced one or more portfolios that passed constraints associated with the prior rebalance; and
re-run the multi-objective evolutionary algorithm to analyze the multiple proposed portfolios in the solution set in combination with the one or more portfolios that passed the constraints associated with the prior rebalance; and
modify the solution set to include one or more of the multiple proposed portfolios or the one or more portfolios that passed the constraints associated with the prior rebalance that best achieve the one or more established objectives.

5. The system of claim 1, wherein the multi-objective evolutionary algorithm uses single point crossover, bit flip mutation, binary tournament selection constrained with values associated with population, generation, and mutation rate variables to analyze the one or more candidate constituents in the rebalance list and produce the solution set.

6. The system of claim 5, wherein the multi-objective evolutionary algorithm associates the candidate constituent subsets in the multiple proposed portfolios with a binary value that describes a Pareto efficient frontier to indicate whether the candidate constituents in the subsets can allocated differently to improve any of the one or more objectives without worsening any of the one or more objectives.

7. The system of claim 5, wherein the multi-objective evolutionary algorithm reduces the value associated with the population variable in response to determining that the one or more established objectives include minimizing price-to-book scores associated with the multiple proposed portfolios in the solution set.

8. The system of claim 1, wherein the winning portfolio that best satisfies the one or more established objectives comprises the one of the subset of the multiple tangency portfolios having a best Sharpe Ratio.

9. The system of claim 1, wherein to compute the multiple tangency portfolios, the one or more mean variance optimization calculations cause the one or more processors to:
select a current proposed portfolio from the multiple proposed portfolios;
form a returns matrix that includes multiple daily returns associated with the current proposed portfolio, wherein the returns matrix has a minimum dimensionality constrained according to how many equities appear in the candidate constituent subsets and a maximum dimensionality constrained according to a size associated with the current proposed portfolio;
use the returns matrix to compute the tangency portfolio associated with the current proposed portfolio and constrain the weights allocated to the candidate constituent subset in the tangency portfolio associated with the current portfolio within a predetermined range;
determine that the tangency portfolio associated with the current portfolio best satisfies the one or more established objectives in response to the tangency portfolio having a turnover value below a predetermined threshold; and
iteratively process a next proposed portfolio in the multiple proposed portfolios until each of the multiple proposed portfolios have been processed with the mean variance optimization calculations.

10. The system of claim 9, wherein the winning portfolio that best satisfies the one or more established objectives comprises one of the multiple tangency portfolios having a lowest turnover value if none of the multiple tangency portfolios satisfy the one or more established objectives.

11. The system of claim 9, wherein to compute the multiple tangency portfolios, the one or more mean variance optimization calculations further cause the one or more processors to:
determine whether a prior rebalance produced a winning portfolio that passed constraints associated with the prior rebalance in response to the turnover value associated with the tangency portfolio meeting or exceeding the predetermined threshold;
order the candidate constituent subset associated with the current portfolio according to the allocated weights and further order multiple equities in the winning portfolio that passed the constraints associated with the prior rebalance according to weights allocated to the one or more equities in the winning portfolio;
generate a list that includes one or more swap candidates, wherein the one or more swap candidates include one or more of the multiple equities in the winning portfolio associated with the prior rebalance that appear in the candidate constituent subsets without appearing in the candidate constituent subset associated with the current portfolio;
shift the weights allocated to each of the candidate constituents in the subset associated with the current portfolio to one of the swap candidates until the turnover value associated with the tangency portfolio does not meet or exceed the predetermined threshold or no further swap candidates remain; and
save the shifted weights allocated to each of the candidate constituents in the subset associated with the current portfolio in response to the shifted weighted resulting in the turnover value not meeting or exceeding the predetermined threshold.

12. The system of claim 9, wherein to compute the multiple tangency portfolios, the one or more mean variance optimization calculations further cause the one or more processors to run the multi-objective evolutionary algorithm to enable allocating zero or minimum non-zero weights to the candidate constituents in the subset associated with the current proposed portfolio.

13. The system of claim 12, wherein the multi-objective evolutionary algorithm generates multiple proposed tangency portfolios that have maximized return values, minimized risk values, and minimized turnover values and selects one of the multiple proposed tangency portfolios that has a highest return-to-risk ratio to be the tangency portfolio associated with the current proposed portfolio.

14. A method for constructing outperforming portfolios relative to target benchmarks, wherein the method comprises:
establishing one or more objectives to construct a portfolio that outperforms a target benchmark index having multiple constituents;
generating, on a processor, a rebalance list that includes one or more candidate constituents selected from the multiple constituents associated with the target benchmark, wherein the rebalance list eliminates one or more of the multiple constituents that cannot contribute to the one or more established objectives;
running, on the processor, a multi-objective evolutionary algorithm to analyze the one or more candidate constituents in the rebalance list and produce a solution set having multiple proposed portfolios that include candidate constituent subsets selected from the one or more candidate constituents to achieve the one or more established objectives; and
executing, on the processor, one or more mean variance optimization calculations to compute multiple tangency portfolios that allocate weights to the candidate constituent subsets in the multiple proposed portfolios, identify a subset of the multiple tangency portfolios that satisfy the one or more established objectives, and select one of the subset of the multiple tangency portfolios that best satisfy the one or more established objectives to be a winning portfolio.

15. The method of claim 14, wherein the one or more of the multiple constituents that cannot contribute to the one or more established objectives include any of the multiple constituents having multi-factor scores, market capitalizations, or daily price data points that fail to meet to exceed a predetermined threshold.

16. The method of claim 15, wherein the one or more established objectives include one or more of maximizing the multi-factor scores, maximizing the market capitalizations, or minimizing price-to-book scores associated with the candidate constituent subsets in the multiple proposed portfolios associated with the solution set.

17. The method of claim 14, further comprising:
determining, on the processor, whether a prior rebalance produced one or more portfolios that passed constraints associated with the prior rebalance; and
re-running, on the processor, the multi-objective evolutionary algorithm to analyze the multiple proposed portfolios in the solution set in combination with the one or more portfolios that passed the constraints associated with the prior rebalance; and
modifying, on the processor, the solution set to include one or more of the multiple proposed portfolios or the one or more portfolios that passed the constraints associated with the prior rebalance that best achieve the one or more established objectives.

18. The method of claim 14, wherein the multi-objective evolutionary algorithm uses single point crossover, bit flip mutation, binary tournament selection constrained with values associated with population, generation, and mutation rate variables to analyze the one or more candidate constituents in the rebalance list and produce the solution set.

19. The method of claim 18, wherein the multi-objective evolutionary algorithm associates the candidate constituent subsets in the multiple proposed portfolios with a binary value that describes a Pareto efficient frontier to indicate whether the candidate constituents in the subsets can allocated differently to improve any of the one or more objectives without worsening any of the one or more objectives.

20. The method of claim 18, wherein the multi-objective evolutionary algorithm reduces the value associated with the population variable in response to determining that the one or more established objectives include minimizing price-to-book scores associated with the multiple proposed portfolios in the solution set.

21. The method of claim 14, wherein the winning portfolio that best satisfies the one or more established objectives comprises the one of the subset of the multiple tangency portfolios having a best Sharpe Ratio.

22. The method of claim 14, wherein computing the multiple tangency portfolios includes:
selecting a current proposed portfolio from the multiple proposed portfolios;
forming, on the processor, a returns matrix that includes multiple daily returns associated with the current proposed portfolio, wherein the returns matrix has a minimum dimensionality constrained according to how many equities appear in the candidate constituent subsets and a maximum dimensionality constrained according to a size associated with the current proposed portfolio;
using the returns matrix to compute the tangency portfolio associated with the current proposed portfolio and constrain the weights allocated to the candidate constituent subset in the tangency portfolio associated with the current portfolio within a predetermined range;
determining that the tangency portfolio associated with the current portfolio best satisfies the one or more established objectives in response to the tangency portfolio having a turnover value below a predetermined threshold; and
iteratively processing, on the processor, a next proposed portfolio in the multiple proposed portfolios until each of the multiple proposed portfolios have been processed with the mean variance optimization calculations.

23. The method of claim 22, wherein the winning portfolio that best satisfies the one or more established objectives comprises one of the multiple tangency portfolios having a lowest turnover value if none of the multiple tangency portfolios satisfy the one or more established objectives.

24. The method of claim 22, wherein computing the multiple tangency portfolios includes:
determining, on the processor, whether a prior rebalance produced a winning portfolio that passed constraints associated with the prior rebalance in response to the turnover value associated with the tangency portfolio meeting or exceeding the predetermined threshold;
ordering, on the processor, the candidate constituent subset associated with the current portfolio according to the allocated weights and further order multiple equities in the winning portfolio that passed the constraints associated with the prior rebalance according to weights allocated to the one or more equities in the winning portfolio;
generating, on the processor, a list that includes one or more swap candidates, wherein the one or more swap candidates include one or more of the multiple equities in the winning portfolio associated with the prior rebalance that appear in the candidate constituent subsets without appearing in the candidate constituent subset associated with the current portfolio;
shifting, on the processor, the weights allocated to each of the candidate constituents in the subset associated with the current portfolio to one of the swap candidates until the turnover value associated with the tangency portfolio does not meet or exceed the predetermined threshold or no further swap candidates remain; and
saving the shifted weights allocated to each of the candidate constituents in the subset associated with the current portfolio in response to the shifted weighted resulting in the turnover value not meeting or exceeding the predetermined threshold.

25. The method of claim 22, wherein computing the multiple tangency portfolios includes running the multi-objective evolutionary algorithm to allocate zero or minimum non-zero weights to the candidate constituents in the subset associated with the current proposed portfolio.

26. The method of claim 25, wherein the multi-objective evolutionary algorithm generates multiple proposed tangency portfolios that have maximized return values, minimized risk values, and minimized turnover values and selects one of the multiple proposed tangency portfolios that has a highest return-to-risk ratio to be the tangency portfolio associated with the current proposed portfolio.
